(19) United States
(12) Patent Application Publication
(10) Pub. No.: US 2009/0072418 A1
(43) Pub. Date: Mar. 19, 2009

(54) MANUFACTURING THIN-FILM TRANSISTOR AND COLOR FILTER SUBSTRATES

(76) Inventors: Jae-Hyuk Chang, Gyeonggi-do (KR); Jung-Woo Seo, Gyeonggi-do (KR); Jung-Woo Park, Gyeonggi-do (KR); Jung-Woo Cho, Gyeonggi-do (KR)

Correspondence Address: MACPHERSON KWOK CHEN & HEID LLP, 2033 GATEWAY PLACE, SUITE 400, SAN JOSE, CA, 95110, US

(21) Appl. No.: 12/048,124

(22) Filed: Mar. 13, 2008

(30) Foreign Application Priority Data
Sep. 18, 2007 (KR) 10-2007-0094463

(51) Int. Cl. B29D 11/00; B29C 35/08

(52) U.S. Cl. 264/1.7; 264/259; 264/496; 264/493

(57) ABSTRACT

A method of manufacturing thin film transistor and color filter substrates suitable for liquid crystal displays comprises imprinting a pattern in a resin layer formed on a substrate by disposing a mold on the resin layer, aligning the mold and the substrate, curing an edge portion of the resin layer, pressing the full area of the resin layer, curing the full area of the resin layer, and separating the mold from the resin layer.

### CROSS-REFERENCE TO RELATED APPLICATIONS

This application claims priority under 35 U.S.C. §119 to Korean Patent Application No. 2007-94463, filed on Sep. 18, 2007 in the Korean Intellectual Property Office (KIPO), the contents of which are herein incorporated by reference in their entirety.

### BACKGROUND OF THE INVENTION

1. Field of the Invention

The present invention relates to manufacturing thin-film transistor (TFT) substrates and color film substrates using an imprinting method.

2. Description of the Related Art

An imprinting method capable of forming a nanoscale fine pattern used in semiconductor and liquid crystal display (LCD) panel manufacturing includes forming a resin layer on a substrate, disposing a mold on the resin layer to align the substrate, pressing the mold by using a roller, curing the resin layer using ultraviolet light, and separating the mold from the resin layer. However, misalignment between the mold and the substrate may occur during the rolling step so that it is necessary to fix the resin layer to the substrate using a clamp. However, even so a fine misalignment may occur. Moreover, the thickness of a portion of the resin layer that is pressed by the clamp may be decreased, causing the resin layer to have non-uniform thickness.

### SUMMARY OF THE INVENTION

The present invention provides a method of manufacturing thin-film transistor (TFT) and color filter substrates by imprinting a pattern that fixes a resin layer to a substrate without misalignment.

In one aspect of the present invention, a pattern is imprinted in a resin layer formed on a substrate by disposing a mold on the resin layer, aligning the mold and the substrate, curing an edge portion of the resin layer, pressing the full area of the resin layer, curing the full area of the resin layer, and separating the mold from the resin layer.

In curing an edge portion of the resin layer, at least one of heat and light, such as ultraviolet light of infrared light is applied to an edge portion of the resin layer. For example, a mask having a light-transmitting portion in correspondence with the resin layer is disposed on the resin layer, and then at least one of the heat and the light is applied to the mask to cure an edge portion of the resin layer.

In an exemplary embodiment, the substrate may have a substantially rectangular shape when viewed from a plan view. In curing an edge portion of the resin layer, at least one of four edge portions of the resin layer may be cured. For one example, three edge portions of the resin layer may be cured. For another example, four edge portions of the resin layer may be cured. For still another example, two edge portions facing each other of the resin layer may be cured. When the four edge portions of the resin layer are cured, the four edge portions of the resin layer are spaced apart from four corner portions of the resin layer to be cured.

In the step of pressing the full area of the resin layer, a roller is disposed at a first side of the mold, and then the roller is rolled toward a second side of the mold, which is opposite to the first side, to form a pattern on the resin layer. Here, a thickness of the pattern may be substantially uniform.

In an exemplary embodiment, an upper portion of the mold may be further pressed by rolling a roller before the mold and the substrate are aligned with each other.

In another aspect of the present invention, in order to manufacture a TFT substrate, a resin layer is formed on a substrate having a TFT formed thereon. The TFT includes a gate electrode electrically connected to a gate line, a source electrode electrically connected to a data line, and a drain electrode spaced apart from the source electrode. A mold is disposed on the resin layer. The mold and the substrate are aligned with each other. An edge portion of the resin layer is cured. The full area of the resin layer is pressed. The full area of the resin layer is cured. The mold is separated from the resin layer.

In the step of curing the full area of the resin layer, a contact hole may be formed through the resin layer, which exposes a portion of the drain electrode. Moreover, a light-transmitting hole may be formed through the resin layer in correspondence with a transmittance area of a transflective-mode liquid crystal display (LCD) panel.

In an exemplary embodiment, a pixel electrode may be further formed on the resin layer, which is electrically connected to the drain electrode through the contact hole, after separating the mold from the resin layer.

In still another aspect of the present invention, in order to manufacture a color filter substrate, a resin layer is formed on a substrate having a color filter formed thereon. Then, a mold is disposed on the resin layer. Then, the mold and the substrate are aligned with each other. Then, an edge portion of the resin layer is cured. Then, the full area of the resin layer is pressed. Then, the full area of the resin layer is cured. Then, the mold is separated from the resin layer.

In the step of pressing the full area of the resin layer, a light-transmitting pattern may be further formed on the resin layer in correspondence with a transmittance area of a transflective-mode LCD panel.

According to the present invention, as the full area of a resin layer is suppressed after an edge portion of the resin layer is cured, a misalignment may be prevented from being generated between a mold and a substrate when the full area of the resin layer is suppressed.

### BRIEF DESCRIPTION OF THE DRAWINGS

The above and other advantages of the present invention will become readily apparent by reference to the following detailed description when considered in conjunction with the accompanying drawings wherein:

FIG. 1 is a cross-sectional view illustrating a step of forming a resin layer on a substrate in an imprinting method according to an exemplary embodiment of the present invention;

FIGS. 2 and 3 are cross-sectional views illustrating a step of disposing a mold on the substrate having a resin layer formed thereon;

FIG. 4 is a cross-sectional view illustrating a step of pressing the mold by rolling a roller;

FIG. 5 is a cross-sectional view illustrating a step of aligning the mold and the substrate to each other;

FIG. 6 is a cross-sectional view illustrating a step of curing an edge portion of the resin layer;

FIG. 7 is a cross-sectional view illustrating a step of re-pressing the mold by rolling a roller;

FIG. 8 is a cross-sectional view illustrating a step of curing the full area of the resin layer;

FIG. 9 is a cross-sectional view illustrating a step of removing the resin layer from the mold;

FIGS. 10, 11, 12 and 13 are plane views illustrating the resin layer having a cured edge portion of FIG. 6;

FIG. 14 is a cross-sectional view illustrating a state in which a mold is disposed on a base substrate having a resin layer formed thereon in a manufacturing method of a thin-film transistor (TFT) substrate in accordance with an exemplary embodiment of the present invention;

FIG. 15 is a cross-sectional view illustrating a state in which rolling a roller after an edge portion of a resin layer is cured to press a mold;

FIG. 16 is a cross-sectional view illustrating a state in which a pixel electrode and a reflective electrode are formed on the resin layer;

FIG. 17 is a cross-sectional view illustrating a state in which a mold is disposed on a base substrate having a resin layer formed thereon in a manufacturing method of a color filter substrate in accordance with an exemplary embodiment of the present invention;

FIG. 18 is a cross-sectional view illustrating a state in which rolling a roller after an edge portion of a resin layer is cured to press a mold; and

FIG. 19 is a cross-sectional view illustrating a state in which a transparent electrode is formed on the resin layer.

### DESCRIPTION OF THE EMBODIMENTS

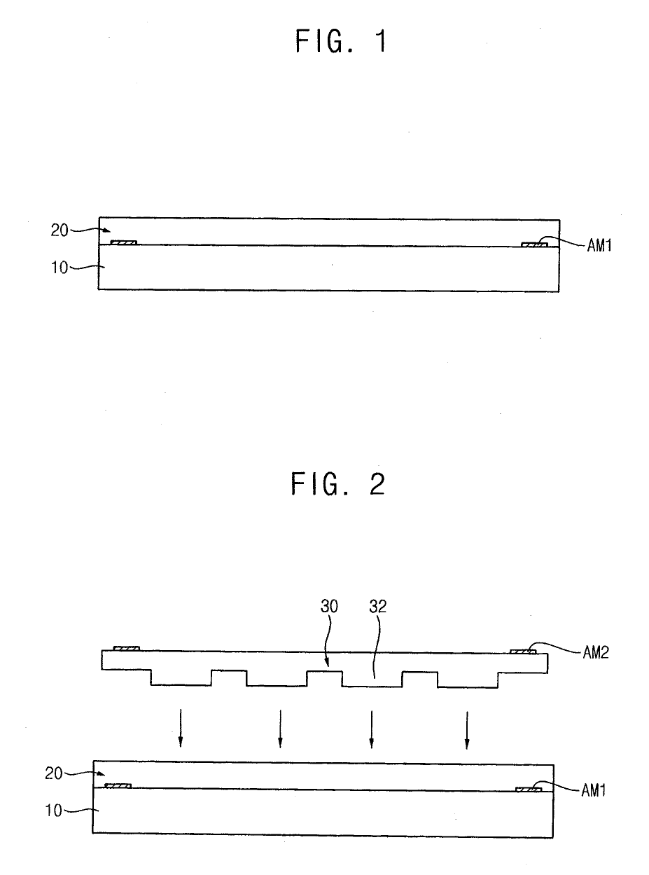

FIG. 1 is a cross-sectional view illustrating a step of forming a resin layer on a substrate in an imprinting method according to an exemplary embodiment of the present invention.

Referring to FIG. 1, a resin layer 20 is formed on a substrate 10 so as to perform an imprinting method according to an exemplary embodiment of the present invention.

The substrate may include, for example, a flat shape. The substrate 10 may have a rectangular shape when viewed from a plan view.

A first alignment mark AM1 may be formed on a first surface of the substrate 10. The first alignment mark AM1 may be formed on at least two of four corner portions of the first surface of the substrate 10. Alternatively, the first alignment mark AM1 may be formed on a second surface of the substrate 10, which is opposite to the first surface.

A predetermined pattern (not shown) except the first alignment mark AM1 may be formed on the first surface of the substrate 10.

The resin layer 20 is formed on the first surface of the substrate 10. The resin layer 20 may have fluidic properties. For example, the resin layer 20 may include a thermoplastic resin, a thermosetting resin, a photo-curable resin, etc. Here, the photo-curable resin may include a fluidic material that is cured by ultraviolet light or infrared light.

Examples of the photo-curable resin may include a urethane-based resin, an epoxy-based resin, an acrylic-based resin, etc. Examples of the thermosetting resin may include a phenol resin, an epoxy resin, a silicon resin, polyimide, etc. Examples of the thermoplastic resin may include polymethyl-methacrylate (PMMA), polycarbonate (PC), polyethylene terephthalate (PET), an acrylic resin, polyacrylate (PAR), polyether sulfone (PES), etc.

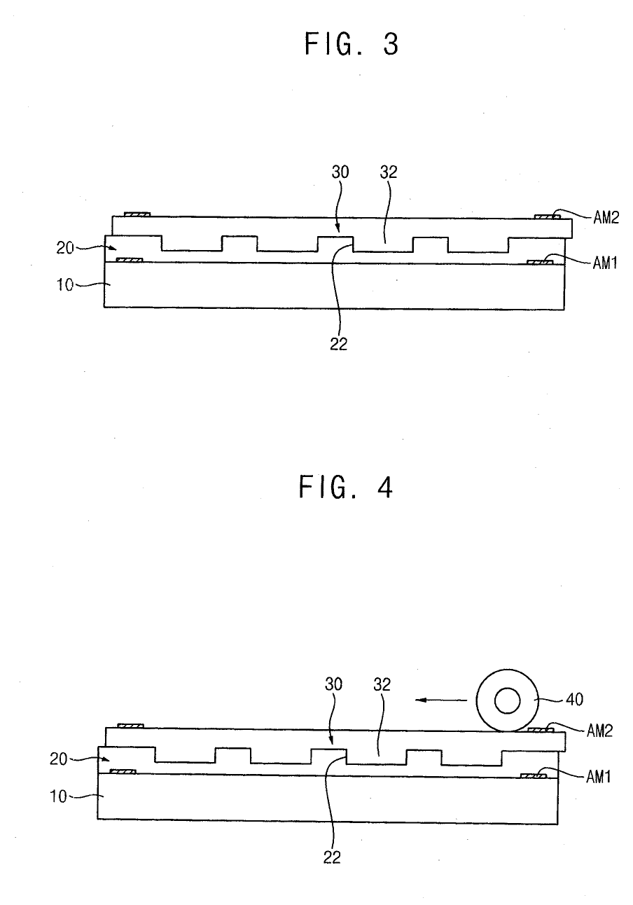

FIGS. 2 and 3 are cross-sectional views illustrating a step of disposing a mold on the substrate having a resin layer formed thereon.

Referring to FIGS. 2 and 3, a mold 30 disposed on the resin layer 20 is moved toward the substrate 10, and then the mold 30 is combined with the resin layer 20.

The mold 30 may include, for example, a flat shape. The mold 30 may have a substantially rectangular shape in correspondence with the substrate 10, when viewed from a plan view. The mold includes at least one of protruding parts 32 that protrudes toward the substrate 10. When the mold 30 is combined with the resin layer 20, the protruding part 32 forms a recess 22 through a surface of the resin layer 20.

The mold may be a soft-type mold. The soft-type mold may include a polymer. For example, the polymer may include a thermoplastic elastomer. For example, the soft-type mold may include polyurethane acrylate (PUA) and polydimethylsiloxane (PDMS).

When a predetermined pattern is formed on a surface of the substrate 10 so that the substrate 10 is non-flat, the soft-type mold may be suitable in an imprinting process.

A merit of the polyurethane acrylate (PUA) or the polydimethyl siloxane (PDMS) included in the soft mold is as follows.

The two materials may be reliably adhered on a relatively wide area of the substrate 10. That is, the two materials may be suitable for an adhering to a non-flat surface, and have a low interface free energy, so that another polymer is not adhered to one of two materials when another polymer is molded on one of two materials. The two materials may have homogeneous and isotropic characteristics and may be optically transparent up to a predetermined thickness, so that the two materials may be used for an optical device. The two materials may be elastomers having superior durability, so that the two materials may be recycled.

For one example, a second alignment mark AM2 for aligning with the first alignment mark AM1 may be formed on a first surface of the mold 30 facing a first surface of the substrate. For another example, a second alignment mark AM2 may be formed on a second surface of the mold 30 opposite to the first surface of the mold 30. For still another example, the second alignment mark AM2 may be formed on at least two of four corner portions of the first surface of the second surface of the mold 30 in correspondence with the first alignment mark AM1.

In this embodiment, the mold 30 may be combined with the resin layer 20 in a state in which the mold 30 is exactly aligned to the substrate 10. That is, the first and second alignment marks AM1 and AM2 may not be aligned with each other.

FIG. 4 is a cross-sectional view illustrating a step of pressing the mold using a roller.

Referring to FIG. 4, a roller 40 is disposed at a first side of the mold 30, and then the mold 30 is pressed toward the substrate 10 by rolling the roller 40. That is, the roller 40 is rolled from a first side of the mold 30 to a second side of the mold 30, so that the mold 30 is pressed toward the substrate 10. Here, the roller 40 may be reciprocated between the first side and the second side of the mold 30.

When the roller 40 presses the mold 30, a pre-pattern is formed on the resin layer 20 and a thickness of the pre-pattern may be uniform.

When the mold 30 is pressed on the resin layer 20 by the roller 40, the mold 30 and the substrate 10 may be spaced apart by a predetermined interval. For example, the mold 30 and the substrate 10 may be spaced apart by about 10 micrometers (μm) to about 100 μm. When the mold 30 and the substrate 10 are spaced apart by a small interval (i.e., less than about 10 μm), the mold 30 may not be easily moved with respect to the substrate 10. When the mold 30 and the substrate 10 are spaced apart by a large interval (i.e., more than about 100 μm), a quantity of resin of the resin layer 20 may be increased, which may be consumed during the imprinting process.

The step of pressing through the roller 40, which is described in FIG. 4, may be optionally omitted. A pressing means for pressing the mold 30 may include the roller 40, a pneumatic generating device, etc. For example, the pneumatic generating device may press the full area of the mold 30 through air instead of the roller 40.

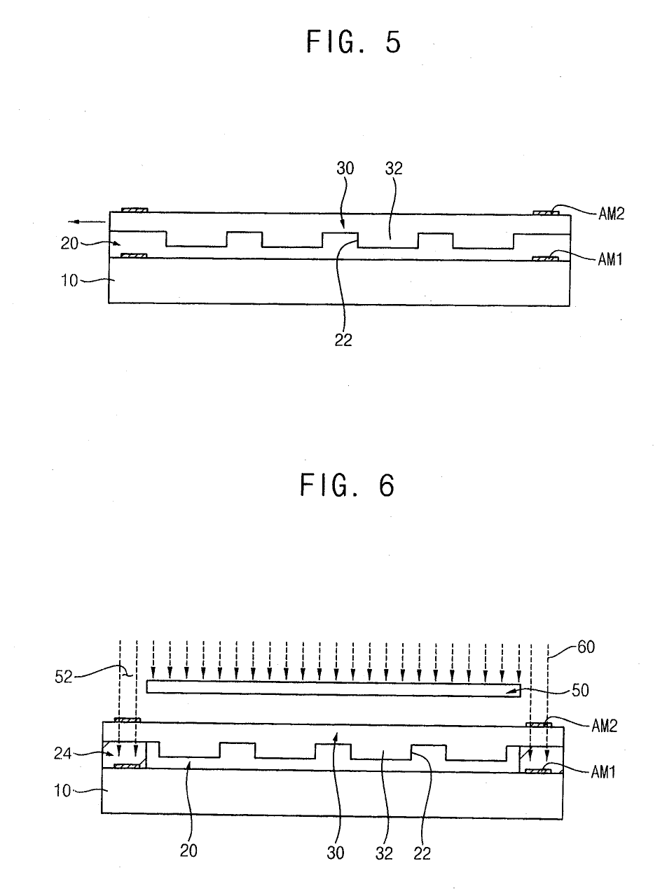

FIG. 5 is a cross-sectional view illustrating a step of aligning the mold and the substrate to each other.

Referring to FIG. 5, the substrate 10 and the mold 30 are aligned with each other. That is, the mold 30 is moved in parallel with the substrate 10 to align the first and second alignment marks AM1 and AM2.

When the substrate 10 and the mold 30 are aligned with each other, a recess 22 formed in the resin layer 20 may be moved to a desired position.

FIG. 6 is a cross-sectional view illustrating a step of curing an edge portion of the resin layer.

Referring to FIG. 6, edge portions of the resin layer 20 is cured after the substrate 10 and the mold 30 are aligned with each other. In the embodiment, the resin layer 20 includes a photo-curable material.

In order to cure edge portions of the resin layer 20, a mask 50 may be used, which has a light-transmitting portion 52 in correspondence with edge portions of the resin layer 20. For example, the mask 50 is disposed on an upper portion of the mold 30, and then light 60 is irradiated on the mask 50. The light 60 is transmitted to the light-transmitting portion 52 to be irradiated to edge portions of the resin layer 20. As a result, the edge portions of the resin layer 20 are cured to form the pre-curing portion 24. The light 60 may have various wavelengths in accordance with a composition material of the resin layer 20. For example, the light 60 may include ultraviolet light or infrared light. Here, detailed descriptions for a formation position for the pre-curing portion 24 will be described with reference to separate drawings.

In FIG. 6, the mask 50 is disposed on the mold 30. Alternatively, the mask 50 may be disposed below the substrate 10. When the mask 50 is disposed below the substrate 10, light generated below the substrate 10 is transmitted through the light-transmitting portion 52 and the substrate 10 to be irradiated to the edge portions of the resin layer 20. As a result, the edge portions of the resin layer 20 are cured, thereby forming the pre-curing portion 24.

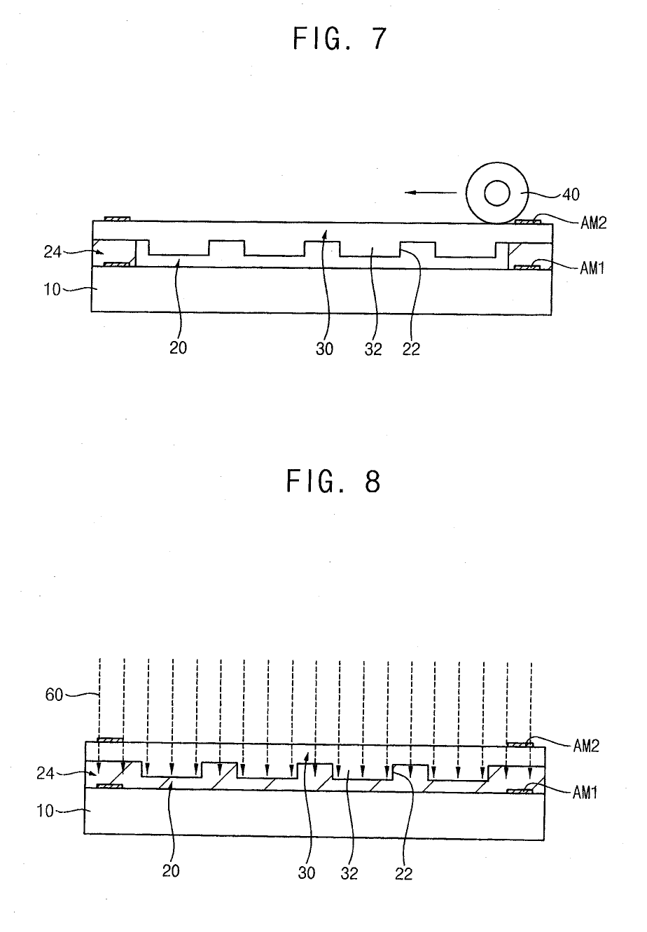

FIG. 7 is a cross-sectional view illustrating a step of re-pressing the mold by rolling a roller.

Referring to FIG. 7, the mold 30 is re-pressed through the roller 40 after the edge portions of the resin layer 20 are cured. That is, the roller 40 is rolled from a first side of the mold 30 to a second side of the mold 30, so that the mold 30 is pressed toward the substrate 10. Here, the roller 40 may be reciprocated between the first side and the second side of the mold 30.

After the roller 40 re-presses the mold 30, an entire pattern is formed on the resin layer 20. Here, a thickness of the entire pattern may be substantially uniform. For example, a thickness of a bottom portion of the recesses 22 formed through the resin layer 20 may be substantially uniform.

According to the present embodiments, the edge portions of the resin layer 20 is cured after the mold 30 and the substrate 10 are aligned with each other, so that the mold 30 may be maintain an original position even though the roller 40 re-presses the mold 30.

FIG. 8 is a cross-sectional view illustrating a step of curing the full area of the resin layer.

Referring to FIG. 8, the light 60 is irradiated to the full area of the resin layer 20 to cure the full area of the resin layer 20. When the full area of the resin layer 20 is fully cured, the cured entire pattern may be formed on a surface of the resin layer 20.

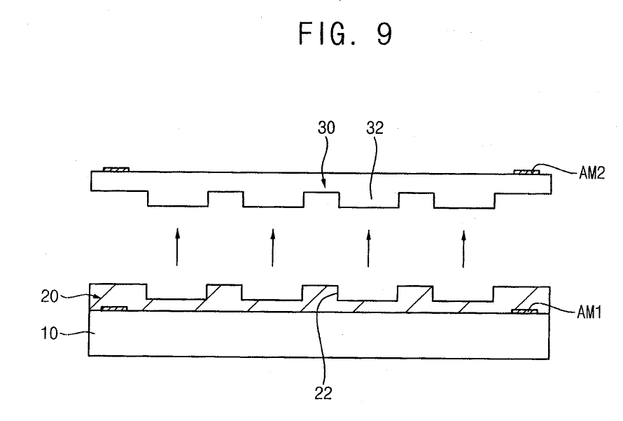

FIG. 9 is a cross-sectional view illustrating a step of removing the resin layer from the mold.

Referring to FIG. 9, the mold 30 is separated from the resin layer 20 after the full area of the resin layer 20 is cured. As a result, a combined structure of the resin layer 20 and the substrate 10 remain.

Alternatively, a plurality of resin layers may be formed on a first surface of the substrate 10 by repeatedly performing the imprinting method.

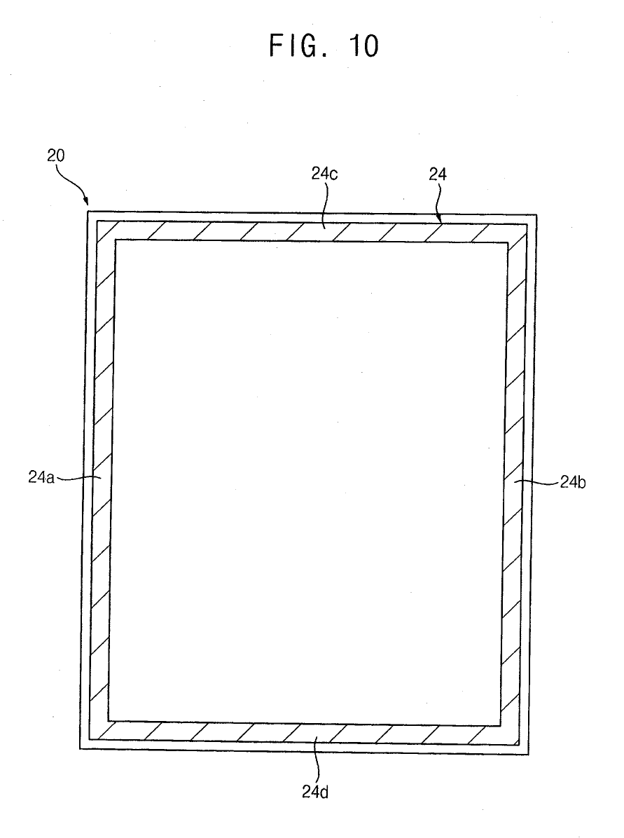

FIGS. 10, 11, 12 and 13 are plane views illustrating the resin layer having a cured edge portion of FIG. 6.

Referring to FIGS. 10, 11, 12 and 13, the pre-curing portion 24 may be formed in at least one of four edge portions of the resin layer 20 in correspondence with four sides of the substrate.

Referring to FIG. 10, the pre-curing portion 24 may include a first curing portion 24a, a second curing portion 24b, a third curing portion 24c and a fourth curing portion 24d in correspondence with the four edge portions of the resin layer 20. The first curing portion 24a and the second curing portion 24b are opposite to each other. The third curing portion 24c and the fourth curing portion 24d are opposite to each other. The third curing portion 24c and the fourth curing portion 24d connect to the first curing portion 24a and the second curing portion 24b. Therefore, the pre-curing portion 24 may include a rectangular shape when viewed from a plan view.

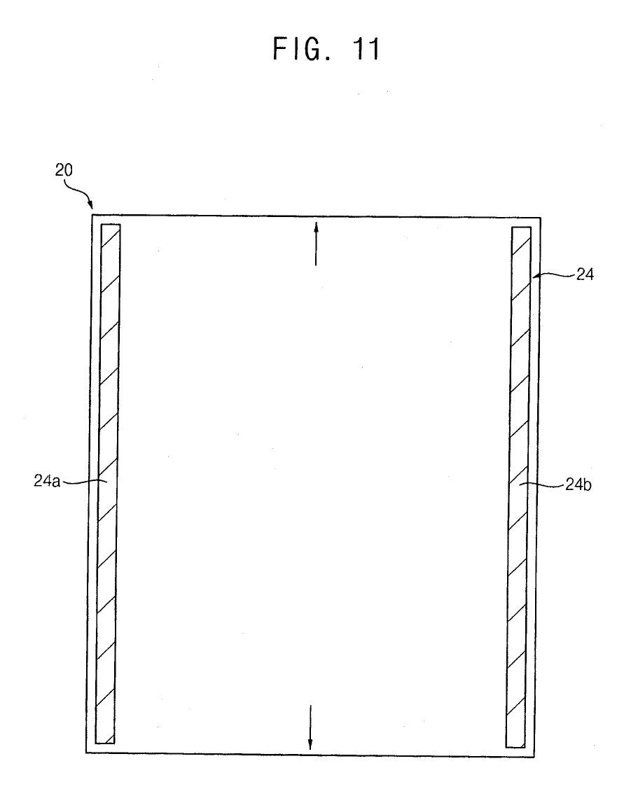

Referring to FIG. 11, the pre-curing portion 24 may include the first and second curing portions 24a and 24b. Alternatively, the pre-curing portion 24 may include the third and fourth curing portions 24a and 24d. That is, the pre-curing portion 24 may be formed at two edge portions that are opposite to each other, among four edge portions of the resin layer 20.

When the pre-curing portion 24 includes the first and second curing portions 24a and 24b and the roller 40 presses the mold 30 as shown in FIG. 7, the resin layer 20 may be extended along a length direction of the first curing portion 24a or the second curing portion 24b.

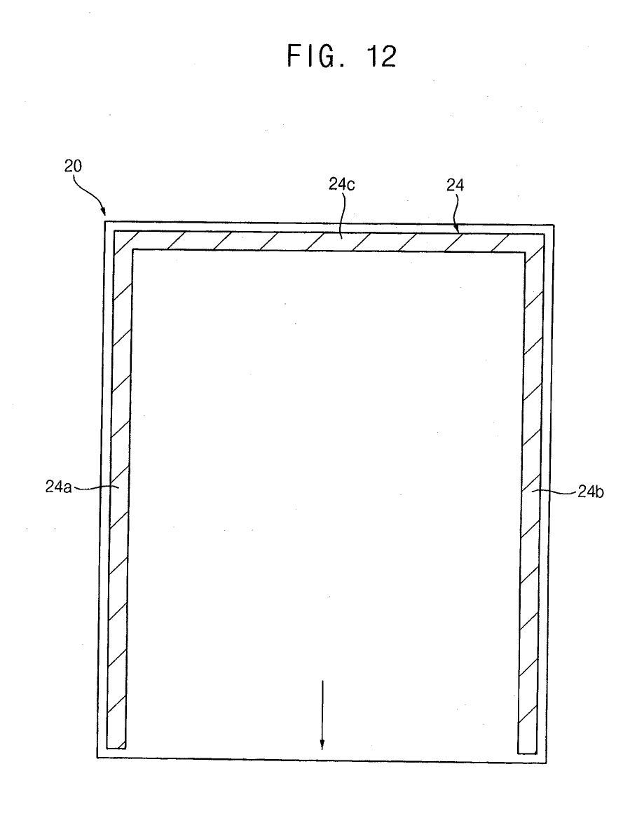

Referring to FIG. 12, the pre-curing portion 24 may include the first curing portion 24a, the second curing portion 24b and the third curing portion 24c. That is, the pre-curing portion 24 may be formed at three edge portions of four edge portions of the rein layer 20.

When the pre-curing portion 24 includes the first, second and third curing portions 24a, 24b and 24c and the roller 40 presses the mold 30 as shown in FIG. 7, the resin layer 20 may be extended along an area in which the pre-curing portion 24 is not formed.

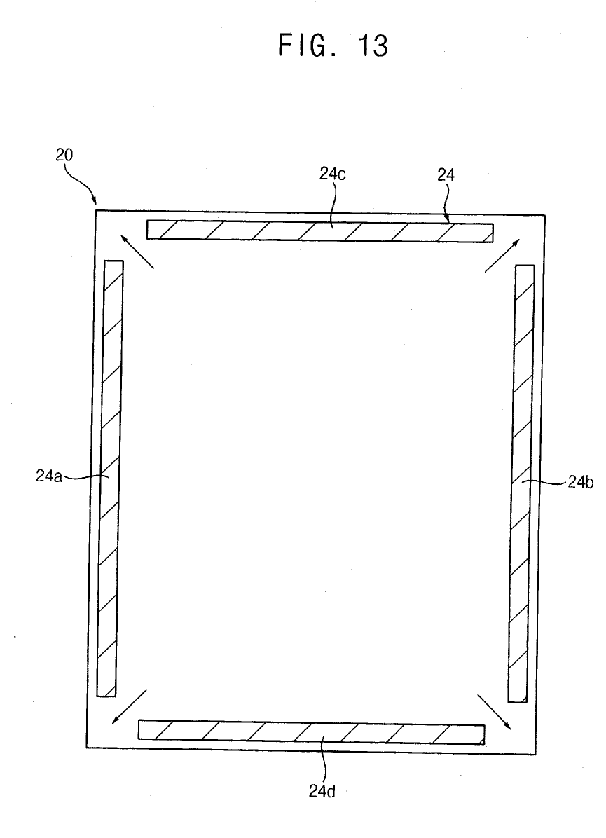

Referring to FIG. 13, the pre-curing portion 24 may include a first curing portion 24a, a second curing portion 24b, a third curing portion 24c and a fourth curing portion 24d in correspondence with the four edge portions of the resin layer 20. Here, the first to fourth curing portions 24a, 24b, 24c and 24d may be spaced apart from four corner portions of the resin layer 20, respectively.

When the pre-curing portion 24 is spaced apart from four corner portions of the rein layer 20 to be formed at the four edge portions, and the roller 40 presses the mold 30 as shown in FIG. 7, the resin layer 20 may be extended along the four corner portions.

Hereinafter, a method of manufacturing a thin-film transistor (TFT) substrate using the imprinting method as described in FIGS. 1 to 13 will be described.

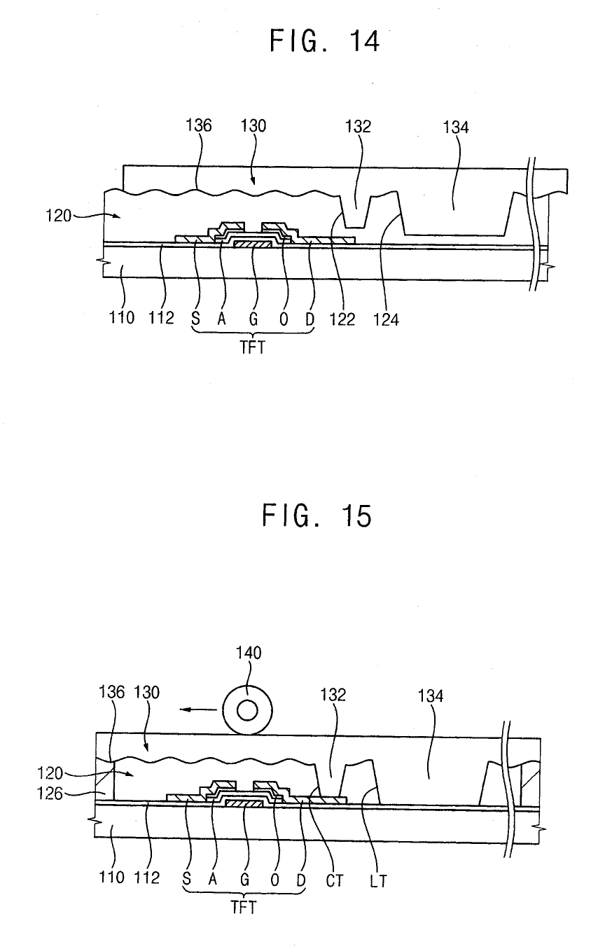

FIG. 14 is a cross-sectional view illustrating a state in which a mold is disposed on a base substrate having a resin layer formed thereon in a manufacturing method of a TFT substrate in accordance with an exemplary embodiment of the present invention.

Referring to FIG. 14, a resin layer 120 is formed on a substrate 110 having a TFT formed thereon so as to manufacture a TFT substrate according to an exemplary embodiment of the present invention.

The TFT, formed on a first surface of the substrate 110, may include a gate electrode G, an active pattern A, a source electrode S, a drain electrode D and an ohmic contact pattern O. For example, the gate electrode G is formed on the first surface of the substrate 110, and is electrically connected to a gate line. A gate insulation layer 112 covering the gate electrode G may be formed on the first surface of the substrate 110. The active pattern A is formed on the gate insulation layer A to be overlapped with the gate electrode G. The source electrode S is formed on the gate insulation layer A to cover a portion of the active pattern A, and is electrically connected to a data line. The drain electrode S is spaced apart from the source electrode S, and is formed on the gate insulation layer A to be covered a portion of the active pattern A. The ohmic contact pattern O is formed between the active pattern A and the source electrode S, and between the active pattern A and the drain electrode D, respectively.

A plurality of the TFTs may be formed on the first surface of the substrate 110. Here, one TFT is illustrated in FIG. 14.

After the resin layer 120 is formed on a first surface of the substrate 110, a mold 130 is disposed on the resin layer 120. Here, the mold 130 may be pressed by a roller and so on.

The mold 130 may include a first protruding part 132 and a second protruding part 134 that are protruded toward the first surface of the substrate 110. Moreover, a concavo-convex part 136 may be formed on the first surface of the mold 130, which is opposite to the first surface of the substrate 110. Here, when the mold 130 is disposed on the resin layer 120, a first recess 122 and a second recess 124 are formed through the resin layer 120, and a concavo-convex surface is formed through a surface of the resin layer 120 by the concavo-convex part 136.

FIG. 15 is a cross-sectional view illustrating a state in which rolling a roller after an edge portion of a resin layer is cured to press a mold.

Referring to FIG. 15, the mold 130 is disposed on the resin layer 120, and then the mold 130 and the substrate 110 are aligned with each other. Here, when the mold 130 and the substrate 110 are aligned with each other, the first recess 122 may be moved toward an upper portion of the drain electrode D, and the second recess 124 may be moved toward a position of a transmitting area of the TFT substrate.

Then, an edge of the resin layer 120 is cured to form a pre-curing portion 126, and then the mold 130 is pressed by rolling a roller 140. Therefore, an entire pattern may be formed through the resin layer 220. Here, a thickness of the entire pattern may be substantially uniform.

The first and second recesses 122 and 124 are moved toward the substrate 110, so that a contact hole CT and a light-transmitting hole LT may be formed. The contact hole CT exposes a portion of the drain electrode D, and the light-transmitting hole LT exposes a portion of the gate insulation layer 112.

Even though the first and second recesses 122 and 124 are moved toward the substrate 110, the contact hole CT and the light-transmitting hole LT may not be formed and a remaining layer may remain. However, the remaining layer is removed using an additional etching process, etc., so that the contact hole CT and the light-transmitting hole LT may be formed.

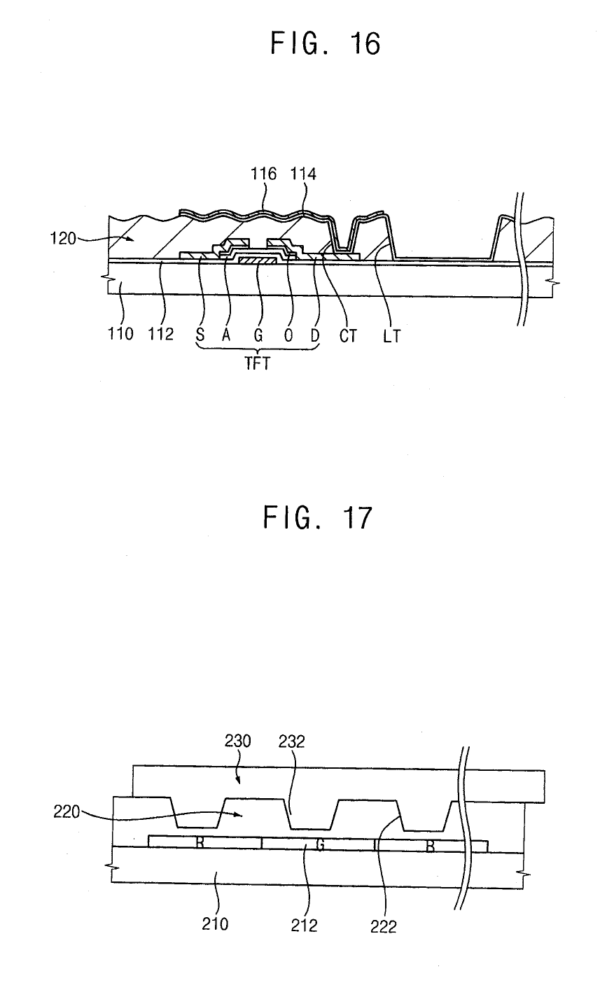

FIG. 16 is a cross-sectional view illustrating a state in which a pixel electrode and a reflective electrode are formed on the resin layer.

Referring to FIG. 16, the mold 130 is pressed by the roller 140, and then the full area of the resin layer 120 is cured. Then, the mold 130 is separated from the resin layer 120.

Then, a pixel electrode 114 including an optically transparent and electrically conductive material is formed on the resin layer 120. Here, the pixel electrode 114 is electrically connected to the drain electrode D through the contact hole CT.

Then, a reflecting electrode 116 including a metal material that reflects light is formed on the pixel electrode 114. Here, an area of the reflecting electrode 116 may correspond to a reflecting area of the TFT substrate, and a remaining area may correspond to a transmitting area of the TFT substrate. The transmitting area may include an area having the light-transmitting hole LT formed thereon.

In FIGS. 14, 15 and 16, it is described that an imprinting method of the present invention may be adopted in a method of manufacturing a transflective-mode TFT substrate. Alternatively, the imprinting method of the present invention may be adopted in a method of manufacturing a TFT substrate having another mode.

Hereinafter, a method of manufacturing a color filter substrate using the imprinting method as described in FIGS. 1 to 13 will be described.

FIG. 17 is a cross-sectional view illustrating a state in which a mold is disposed on a base substrate having a resin layer formed thereon in a manufacturing method of a color filter substrate in accordance with an exemplary embodiment of the present invention.

Referring to FIG. 17, a resin layer 220 is formed on a first surface of a substrate 210 having a color filter 212 formed thereon so as to manufacture a color filter substrate according to an exemplary embodiment of the present invention.

The color filter 212 may include a red color filter, a green color filter and a blue color filter.

A mold 230 is disposed on the resin layer 220 after the resin layer 220 is formed on the first surface of the substrate 210. Here, the mold 230 may be pressed by a pressing device such as a roller. The mold 230 may include at least one of protruding part 232 protruding toward the first surface of the substrate 210. The protruding part 232 may form a recess 222 through the resin layer 220.

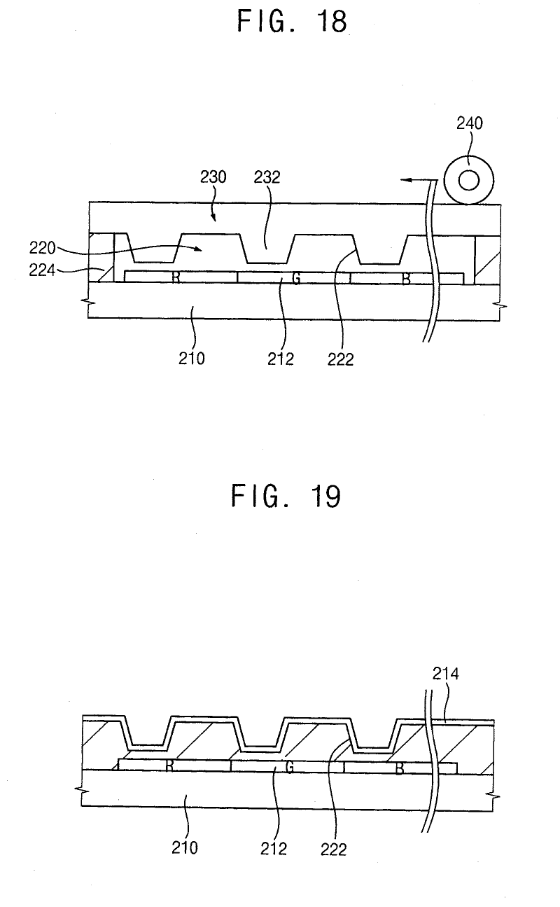

FIG. 18 is a cross-sectional view illustrating a state in which rolling a roller after an edge portion of a resin layer is cured to press a mold.

Referring to FIG. 18, the mold 230 is disposed on the resin layer 220, and then the mold and the substrate 210 are aligned with each other. Therefore, a recess 222 formed through the resin layer 220 may be moved to a desired position.

Then, edge portions of the resin layer 220 are cured to form a pre-curing portion 224, and then the mold is pressed by rolling a roller 240. Therefore, an entire pattern may be formed through the resin layer 220. Here, a thickness of the entire pattern may be substantially uniform.

The entire pattern may include a light-transmitting pattern and a column spacer pattern. The light-transmitting pattern is formed in correspondence with a transmitting area of a transflective-mode LCD panel. For example, the light-transmitting pattern may include a recess shape or a hole shape. The column spacer may be a protruding pattern having a predetermined height, which is protruded from a surface of the resin layer.

FIG. 1 9 is a cross-sectional view illustrating a state in which a transparent electrode is formed on the resin layer.

Referring to FIG. 19, the mold 230 is suppressed by the roller 240, and then the full area of the resin layer 220 is cured.

Then, the mold 230 is separated from the resin layer 220, and then a common electrode 214 including an optically transparent and electrically conductive material is formed on the resin layer 220.

According to the present invention, as the full area of a resin layer is suppressed after an edge portion of the resin layer is cured, a misalignment may be prevented from being generated between a mold and a substrate when the full area of the resin layer is suppressed.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A method of imprinting a pattern, the method comprising:
forming a resin layer on a substrate;
disposing a mold on the resin layer;
aligning the mold and the substrate to each other;
curing an edge portion of the resin layer;
pressing the resin layer;
curing the resin layer; and
separating the mold from the resin layer.

2. The method of claim 1, wherein curing the edge portion of the resin layer comprises applying at least one of heat or light to the edge portion of the resin layer to cure the edge portion of the resin layer.

3. The method of claim 2, wherein curing the edge portion of the resin layer comprising:
disposing a mask having a light-transmitting portion in correspondence with the edge portion of the resin layer on the resin layer; and
applying at least one of the heat or the light to the mask.

4. The method of claim 2, wherein the light comprises ultraviolet light or infrared light.

5. The method of claim 1, wherein the substrate comprises four sides of rectangular shape when viewed from a plan view, and
the resin layer comprises four edge portions in correspondence with the four sides of the rectangular shape.

6. The method of claim 5, wherein curing the edge portion of the resin layer comprises:
curing three edge portions of the four edge portions of the resin layer.

7. The method of claim 5, wherein curing the edge portion of the resin layer comprises curing four edge portions of the resin layer.

8. The method of claim 7, wherein curing the edge portion of the resin layer comprises curing four edge portions of the resin layer to be spaced apart from four corner portions of the resin layer.

9. The method of claim 5, wherein curing the edge portion of the resin layer comprises curing two edge portions of four edge portions of the resin layer, the two edge portions being opposite to each other.

10. The method of claim 1, wherein pressing the resin layer comprises:
disposing a roller on a first side of the mold; and
rolling the roller toward a second side of the mold opposite the first side to form a pattern on the resin layer.

11. The method of claim 10, wherein pressing the resin layer comprises forming a substantially uniform thickness of the pattern.

12. The method of claim 1, further comprising pressing an upper portion of the mold by rolling a roller before aligning the mold and the substrate to each other.

13. The method of claim 1, wherein the mold is a soft-type mold.

14. The method of claim 1, wherein aligning the mold and the substrate to each other comprises matching a first align mark formed in the substrate and a second align mark formed in the mold.

15. A method of manufacturing a thin-film transistor substrate, the method comprising:
forming a resin layer on a substrate having the thin-film transistor formed thereon,
disposing a mold on the resin layer;
aligning the mold and the substrate to each other;
curing an edge portion of the resin layer;
pressing the resin layer;
curing the resin layer; and
separating the mold from the resin layer.

16. The method of claim 15, wherein pressing the resin layer comprises forming a contact hole through the resin layer, which exposes a portion of a drain electrode.

17. The method of claim 16, wherein pressing the resin layer further comprises forming a light-transmitting hole through the resin layer in correspondence with a transmittance area of a transreflective-mode liquid crystal display panel.

18. The method of claim 16, further comprising forming a pixel electrode on the resin layer, which is electrically connected to the drain electrode through the contact hole, after separating the mold from the resin layer.

19. A method of manufacturing a color filter substrate, the method comprising:
forming a resin layer on a substrate having a color filter formed thereon;
disposing a mold on the resin layer;
aligning the mold and the substrate to each other;
curing an edge portion of the resin layer;
pressing the resin layer;
curing the resin layer; and
separating the mold from the resin layer.

20. The method of claim 19, wherein pressing the resin layer further comprises forming a light-transmitting pattern on the resin layer in correspondence with a transmittance area of a transflective-mode liquid crystal display panel.
